(19) United States
(12) Patent Application Publication
(10) Pub. No.: US 2025/0383959 A1
(43) Pub. Date: Dec. 18, 2025

(54) MEMORY DEVICE USING ERROR CHECK AND SCRUB WITH SHARED SCRUB LOOP

(71) Applicant: Micron Technology, Inc., Boise, ID (US)

(72) Inventors: Bryan David Kerstetter, Kuna, ID (US); John David Porter, Boise, ID (US); Donald M. Morgan, Meridian, ID (US); Alan J. Wilson, Boise, ID (US)

(21) Appl. No.: 18/783,057

(22) Filed: Jul. 24, 2024

Related U.S. Application Data
(60) Provisional application No. 63/658,967, filed on Jun. 12, 2024.

(51) Int. Cl. G06F 11/10

(52) U.S. Cl. CPC G06F 11/106; G06F 11/1004; G06F 11/1068

(57) ABSTRACT

Systems, methods, and apparatus for memory management operations in a memory device. In one approach, each of multiple banks in a memory array includes a scrub holding register. Data is scrubbed in the background by moving data from a location in a memory array to the scrub holding register. Data in the scrub holding register is scrubbed by error correction circuitry shared by the multiple banks. Status data is recorded for any writes that occur to the array location during the scrubbing. After scrubbing is complete, some or all portions of the scrubbed data are moved back to the array location. The status data is used to identify those portions to move back.

### RELATED APPLICATIONS

The present application claims priority to Prov. U.S. Pat. App. Ser. No. 63/658,967 filed Jun. 12, 2024, the entire disclosure of which application is hereby incorporated herein by reference.

### FIELD OF THE TECHNOLOGY

At least some embodiments disclosed herein relate to memory devices in general, and more particularly, but not limited to memory devices that perform memory management operations (e.g., scrubbing).

### BACKGROUND

Memory devices can include semiconductor circuits that provide electronic storage of data for a host system (e.g., a server or other computing device). Memory devices may be volatile or non-volatile. Volatile memory requires power to maintain data, and includes devices such as random-access memory (RAM), static random-access memory (SRAM), dynamic random-access memory (DRAM), or synchronous dynamic random-access memory (SDRAM), among others. Non-volatile memory can retain stored data when not powered, and includes devices such as flash memory, read-only memory (ROM), electrically erasable programmable ROM (EEPROM), erasable programmable ROM (EPROM), resistance variable memory, such as phase change random access memory (PCRAM), resistive random-access memory (RRAM), or magnetoresistive random access memory (MRAM), among others.

Host systems (e.g., a host device) can include a host processor, a first amount of host memory (e.g., main memory, often volatile memory, such as DRAM) to support the host processor, and one or more storage systems (e.g., non-volatile memory, such as flash memory) that provide additional storage to retain data in addition to or separate from the main memory.

A storage system, such as a solid-state drive (SSD), can include a memory controller and one or more memory devices, including a number of (e.g., multiple) dies or logical units (LUNs). In certain examples, each die can include a number of memory arrays and peripheral circuitry thereon, such as die logic or a die processor. The memory controller can include interface circuitry configured to communicate with a host device (e.g., the host processor or interface circuitry) through a communication interface (e.g., a bidirectional parallel or serial communication interface). The memory controller can, for example, receive commands or operations from the host system in association with memory operations or instructions, such as read or write operations to transfer data (e.g., user data and associated integrity data, such as error data or address data, etc.) between the memory devices and the host device, erase operations to erase data from the memory devices, perform drive management operations (e.g., data migration, garbage collection, block retirement, etc.)

Many memory devices, particularly non-volatile memory devices, such as NAND flash devices, etc., frequently relocate data or otherwise manage data in the memory devices (e.g., garbage collection, wear leveling, drive management, etc.). NAND flash is a type of flash memory constructed using NAND logic gates. Alternatively, NOR flash is a type of flash memory constructed using NOR logic gates.

Volatile memory devices such as DRAM typically refresh stored data. For example, refresh is activating and then precharging a row. At activation time the data in the cells are sensed (implicitly read), and at precharge time the data is written back to the cells (implicitly written).

Storage devices can have controllers that receive data access requests from host computers and perform programmed computing tasks to implement the requests in ways that may be specific to the media and structure configured in the storage devices. In one example, a flash memory controller manages data stored in flash memory and communicates with a computing device. In some cases, flash memory controllers are used in solid-state drives for use in mobile devices, or in SD cards or similar media for use in digital cameras.

Firmware can be used to operate a flash memory controller for a particular storage device. In one example, when a computer system or device reads data from or writes data to a flash memory device, it communicates with the flash memory controller.

Although current memory technologies provide for various functionality and benefits, situations often arise that may potentially cause degradation to the memory devices, potential data loss, damage to memory cells of the memory devices, among potential harmful effects to the memory devices. For example, certain memory cells of a memory array may be the target of a disproportionate number of read operations, write operations, other operations, or a combination thereof, when compared to other memory cells of the memory array. In such instances, such memory cells may wear out faster than other less-frequently-used memory cells.

Various techniques exist for extending the life of memory cells and/or balancing memory usage in memory devices. For example, scrubbing can be used to correct errors in data stored in a memory array of a DRAM. For example, wear leveling is a memory management technique that can extend the useful life of the memory cells of a device by effectively spreading memory usage across the various sections of the memory array so that the sections experience comparable memory usage. Wear leveling, for example, may involve transferring data from source memory rows located in a section of a memory array to target rows that may be located in another section of the memory array and then mapping the addresses of the source memory rows to addresses corresponding to the target memory rows. Memory management technologies may be enhanced to reduce the amount of memory resources utilized to conduct memory management, reduce errors in data and error correction bits, and further extend the life of memory.

### BRIEF DESCRIPTION OF THE DRAWINGS

The embodiments are illustrated by way of example and not limitation in the figures of the accompanying drawings in which like references indicate similar elements.

FIG. 1 shows a memory device having error correction circuitry using a scrub loop to scrub data stored in one or more memory arrays, in accordance with some embodiments.

FIG. 2 shows circuitry to correct errors in pages stored in a memory array, in accordance with some embodiments.

FIG. 3 shows sense amplifier latches to hold data associated with memory cells of a memory array, in accordance with some embodiments.

FIG. 4 shows a bank having a scrub holding register that holds data copied from a memory array for scrubbing, in accordance with some embodiments.

FIG. 5 shows the bank of FIG. 4 during scrub operations using an ECC engine, in accordance with some embodiments.

FIG. 6 shows the transfer during a second scrub operation of scrubbed data back to the address in the bank of FIG. 4 from which the data was copied in a first scrub operation, in accordance with some embodiments.

FIG. 7 shows a non-limiting example of the transfer of scrubbed data back to a memory array based on a state of update latches, in accordance with some embodiments.

FIG. 8 shows a data path for read and write operations for a host device, and a scrub loop shared by multiple banks for servicing scrubbing operations, in accordance with some embodiments.

FIG. 9 shows banks of a memory management group coupled to a scrub ECC engine, in accordance with some embodiments.

FIG. 10 shows a process for scrubbing multiple banks in a memory management group, in accordance with some embodiments.

FIG. 11 shows error correction circuitry for scrubbing code words from a bank of a memory array, in accordance with some embodiments.

FIG. 12 shows a method for scrubbing data in a memory array using temporary storage, in accordance with some embodiments.

FIG. 13 shows equations for determining tECSint and ECS overhead, in accordance with some embodiments.

### DETAILED DESCRIPTION

The following disclosure describes various embodiments for performing memory management operations (e.g., error correction to scrub stored data) using a scrub loop associated with one or more memory arrays. At least some embodiments herein relate to a non-volatile memory device that includes a scrub loop used for scrubbing operations. In some embodiments, a volatile memory device uses a scrub loop for scrubbing data (e.g., error check and scrub in a DRAM). These memory devices may, for example, store data used by a host device (e.g., a computing device of an autonomous vehicle, or another computing device that accesses data stored in the memory device). In one example, the memory device is a solid-state drive mounted in a vehicle.

One type of memory management operation is an error check and scrub (ECS) used in volatile memory devices (e.g., DRAM). ECS is a systematic routine that scrubs an entire memory array. ECS is used to reduce the likelihood that correctable soft errors accumulate into an uncorrectable error.

A code word counter (e.g., ECS counter) is implemented on, for example, the DRAM to count through all code words that exist on the DRAM. Every certain time interval (tECSint), an ECS operation occurs. For example, the entire array is scrubbed every 24 hours (24 hours×60 minutes×60 seconds=86,400 seconds). Thus, tECSint (average periodic interval per ECS operation)=86,400 seconds/code words per DRAM. In one example, the DDR5 specification may recommend that an entire memory array is scrubbed every 24 hours.

The ECS operation may be triggered automatically or manually. When done automatically, a refresh command is stolen to trigger the ECS operation. More generally, a refresh command issued by a controller normally triggers a refresh operation. However, when a refresh command is stolen for another purpose, the refresh command does not trigger a refresh operation. Instead, the refresh command triggers some other arbitrary or defined operation. For example, this other operation may be a row hammer refresh (RHR) or an ECS operation.

When the ECS operation is triggered manually, a special command (e.g., multi-purpose command with a specified op code) is issued by a controller to trigger the ECS operation.

In one example, scrub operations are triggered by an activity-based (e.g., a refresh management (RFM) command for DRAM) or periodic memory management (MM) command (e.g., based on a repeating time interval). Each memory management command causes a portion of scrubbing to occur for a memory management group. Each memory management group can contain one or more banks.

The use of ECS may provide some operational transparency to the controller (e.g., error counts, row addresses with errors, etc.). In one example, providing transparency to the controller includes indicating to the controller that there is a row address with a greatest number of errors for the given ECS period. The controller can read which row has the greatest number of errors. The controller could, based on this information, repair that row.

In one example, the controller is a master controller controlling multiple memory chips. The master controller is external to the memory chips (e.g., DRAM devices) and exists on a separate integrated circuit of a different chip. As such, this master controller controls a multiplicity of DRAM chips.

Scrubbing is generally used to correct errors that occur during operation of a memory device. For example, storage elements in a DRAM may undergo soft errors due to various phenomenon such as neutron strikes or row hammer. A DRAM device may implement an ECC scheme to improve performance. Furthermore, the DRAM device may implement a systematic and periodic scrub routine (e.g., error check and scrub (ECS)) to reduce the likelihood that correctable soft errors accumulate into an uncorrectable soft error.

A scrub routine typically requires some set of data to be read, corrected by an ECC engine, and then written back to the array. Historically, each bank may contain its own ECC engine. However, certain layout area constraints may result in using a per-bank ECC engine to be unfeasible. For example, using an ECC engine per multiple banks may be desired to reduce die area.

In some cases, there may be an ECC engine per bank group. If there is an ECC engine for a plurality of banks, during the scrub operation (e.g., ECS operation) the standard data path may be busy such that read and write operations to other banks may be inhibited. Inhibited read and write commands result in reduced system performance.

In some cases, weak process characteristics may require use of a reduced scrub period (e.g., the time period to scrub an entire memory die). Traditionally, this may be achieved by stealing more refresh cycles for ECS. However, stealing more refresh cycles results in greater ECS overhead (e.g., time the memory array is unusable due to ECS as a proportion of the total time for a scrub period). Thereby, this results in greater refresh overhead (e.g., time the memory array is unusable due to time spent in refresh as a proportion of the total time for a refresh period). Thus, there is a need for a memory device that enables multiple banks to use a single ECC engine to scrub data during an ECS operation (while improving ECS overhead and not reducing system performance).

Various embodiments of the present disclosure provide a technological solution to one or more of the above technical problems. In one embodiment, each group of banks in a memory device contains its own standard ECC engine (e.g., located at the edge of the bank group). This ECC engine operates during standard read and write commands using a standard data path.

An additional scrub ECC engine is used in a separate channel to facilitate ECC scrubbing (e.g., during ECS and/or wear leveling movements). A serial transmission loop is used to allow background communication between the banks of the memory management group and the scrub ECC engine. Advantages include that the standard data path is not disturbed. The standard ECC engine(s) service reads and writes, and a separate ECC engine(s) service ECC scrub or other memory management operations (e.g., scrubbing during ECS).

In one embodiment, an ECC engine is shared across multiple banks of a DRAM device for the purpose of facilitating ECC scrubs. The ECC scrubs may be the scrubs required to perform an Error Check and Scrub (ECS) operation. A holding register is used for each bank. The holding register stores the contents of a plurality of code words pointed to by an ECS counter for transmission to the shared ECC engine and stores scrubbed data received from the ECC engine.

In between ECS operations, data may be read and written from the array location pointed to by the ECS counter while appropriately updating update latches. The number of update latches used is dependent upon the number of code words transferred to/from the holding register. This results in scrubbed data that is composed of a combination of code words that exist in the holding register and the array. The specific combination is dependent upon the state of each update latch. The scrubbing of the array can be performed concurrently with normal DRAM operation (e.g., reads and writes for an external device).

In one embodiment, a volatile memory device includes a register (e.g., scrub holding register) for each of multiple banks in a memory array. A controller moves data stored at an address in a first bank (e.g., source page at an address pointed to by an ECS counter) to a first register. A scrub ECC engine is used to scrub the data in the first register to provide scrubbed data. The controller writes at least a portion of the scrubbed data back to the address in the first bank (e.g., overwrites data stored in the source page).

In one embodiment, a memory device uses a plurality of latches to track write activity that occurs during background scrubbing. A controller scrubs first data stored in a memory array to provide scrubbed data. The latches are updated based on a write operation(s) that occurs while scrubbing the first data. The controller may overwrite, using the scrubbed data and based on a state of the updated latches, at least a portion of the first data. In a case where a write has occurred to all relevant code words (e.g., all of the update latches associated with the code words are high), then no overwriting occurs.

In one embodiment, a memory device includes a temporary storage location (e.g., holding register) and at least one controller. The controller copies a page of stored data from a memory array to the temporary storage location for scrubbing to provide scrubbed data. The controller writes new data to the page in the memory array during the scrubbing. The controller updates a portion of the page in the memory array using the scrubbed data.

Various advantages can be provided by at least some embodiments described herein. For example, die area is reduced in the case of a non-COA (CMOS Over Array) or non-CUA (CMOS Under Array) memory device. For example, an ECS solution is provided in the case that a per-bank ECC Engine cannot be implemented entirely under, over, or alongside the array. For example, the above solution does not or only minimally alters existing specifications.

As other examples, ECS overhead may be reduced (e.g., less stolen refresh cycles for ECS). A smaller scrub period (e.g., period to scrub the entire memory die) can be accommodated, which could accommodate weaker process characteristics. A byproduct of the reduced ECS overhead is reduced refresh overhead. Background scrubbing of the array can be done. The above solution allows scrubbing of the array to occur concurrent with normal operation. The above solution can provide greater toleration of soft errors, may allow weaker process characteristics to be acceptable, may allow acceptable reliability in high-radiation environments, and may generally increase reliability.

In one embodiment, a code word ECC engine is used to detect and correct errors on a given code word. The code word consists of data and parity to be processed by the code word ECC engine. A scrub by the code word ECC engine is triggered by a memory management operation.

In one embodiment, a memory device includes at least one memory array, and at least one controller. The controller performs read and write operations for first data in the memory array using error correction, and scrubs second data in the memory array during the read and write operations. The read and write operations use first error correction circuitry (e.g., main ECC engine), and the scrubbing uses second error correction circuitry (e.g., separate ECC engine connected to memory banks using a scrub loop). In one embodiment, the memory array is configured in a volatile memory device (e.g., DRAM), and the second data is scrubbed as part of an error check and scrub (ECS) operation.

In one embodiment, a DRAM device performs an error check and scrub (ECS) operation. A scrub loop is utilized to facilitate scrubs during ECS operations. This requires using one holding register (e.g., scrub holding register). A number of update latches used (as described below) is dependent upon the number of code words transferred to/from the holding register. The scrubbed data is written to the same array location (e.g., array location pointed to by ECS counter).

In one embodiment, a controller scrubs data stored in a source page of a memory array and performs an operation to write data to the source page while the scrubbing is still being performed in the background.

In one embodiment for a memory device, each bank group contains its own standard ECC engine located at the physical layout edge of the bank group. This standard ECC engine operates during standard read and write commands (e.g., received from a host device). Additional shared scrub ECC engine(s) are added in a channel to facilitate ECC scrubbing. The channel is separate from a data path used for handling the standard read and write commands. A serial transmission loop is used to allow background communication between the banks and the scrub ECC engine.

Each bank includes a scrub holding register. A first memory management command is used to initiate scrubbing (e.g., for a code word), and a second memory management command is used to conclude this scrubbing.

The scrub holding register stores contents of the source data (e.g., an entire row or a number of code words from a row) for transmission to the scrub ECC engine. The scrub holding register receives and stores scrubbed source data from the scrub ECC engine.

An update latch is used for each column (e.g., code word or data plus parity). The update latches are used to track which of the columns have been written to since receiving the first memory management command. In other words, the latches track which columns (e.g., code words) have been written to while the scrubbing is being performed by the scrub ECC engine.

When data scrubbing is complete, the scrubbed data is moved back to the source location. The data is moved back according to the state of the update latches. In this way, the data moved back to the source location (e.g., row) will not change or affect any new data that was written to the source location during the background scrubbing.

Memory management to memory management command spacing (e.g., tMM2MM) is made greater than an elapsed time between all banks in a memory management group (e.g., MM Bank) sending source data and then all banks in the group (e.g., MM Bank) receiving scrubbed source data. The serial transmission loop can be a scrub loop consisting of a bi-directional bus from the banks to/from the scrub ECC engine, or uni-directional buses from the banks to/from the scrub ECC engine.

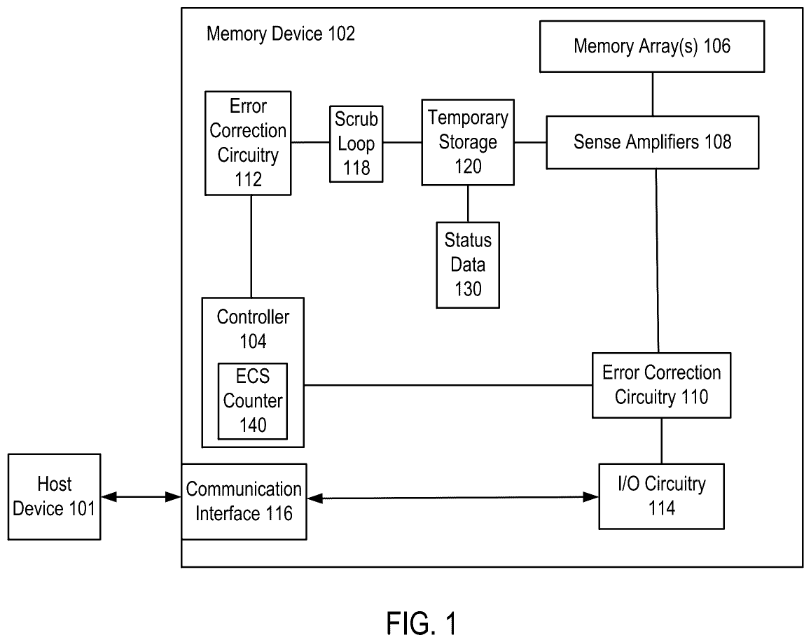

FIG. 1 shows a memory device 102 having error correction circuitry 112 using a scrub loop 118 to scrub data stored in one or more memory arrays 106, in accordance with some embodiments. In one embodiment, error correction circuitry 112 services memory management operations performed on data stored in memory array(s) 106.

Portions of data from memory array 106 are copied to temporary storage 120 during this servicing.

In one example, temporary storage 120 includes scrub holding registers as mentioned above. In one example, error correction circuitry 112 is a scrub ECC engine. In one example, scrub loop 118 is a data path that is separate from a data path used for standard read and write operations for host device 101.

While data is being serviced by the ECC engine, the data is stored in temporary storage 120. In one example, the data has been copied from a source page of memory array 106 using sense amplifiers 108. In some cases, write operations will be performed by controller 104 and/or host device 101 to the address location of the source page that is being serviced. Indications are stored regarding any such write operations that occur. These indications are stored as status data 130.

In one example, status data 130 is stored by a plurality of update latches. A state of each latch is used to indicate whether a column or code word of the page has been written to while being serviced by error correction circuitry 112. For example, controller 104 uses status data 130 when copying scrubbed data back to a source page in memory array 106. In one example, the source page is a set of data pointed to by ECS counter 140. In one example, the set of data is a row of array 106.

In one embodiment, ECS counter 140 points to one or more rows of memory array 106. Code words stored in these rows are moved to one or more scrub holding registers in temporary storage 120. Error correction circuitry 112 uses scrub loop 118 to scrub the code words in temporary storage 120. While this data is being scrubbed, controller 104 can perform read and/or write operations on various rows in array 106 and does error correction on read or write data using error correction circuitry 110.

After scrubbing the code words stored in temporary storage 120, controller 104 writes back one more scrubbed code words to the rows pointed to by ECS counter 140. The scrubbed code words that are written back are selected based on status data 130. In one embodiment, status data 130 is provided by the state of update latches that are updated to indicate write operations that have occurred to the rows pointed to by ECS counter 140.

In one embodiment, memory device 102 is a DRAM device that uses an error check and scrub (ECS) mode. On a periodic basis, controller 104 grabs data from a certain row in the array, scrubs the data with an ECC engine, and then puts the data back to that row. The certain row is pointed to by the ECS counter 140. A main ECC engine (e.g., error correction circuitry 110) is shared among multiple banks for reads and writes. A separate ECC engine (e.g., error correction circuitry 112) with scrub loop 118 is used to permit performing the ECS scrub on the same bank or a different bank from a bank being read or written at the same time. The ECS counter 140 is incremented as rows are scrubbed so that all rows in array 106 are scrubbed within a defined time period (e.g., every 24 hours).

Error correction circuitry 110 services read and write operations on a separate data path from the scrub loop 118. For example, the read or write operations are performed in response to commands or other signals received from host device 101.

Controller 104 accesses portions of memory array(s) 106 in response to commands received from host device 101 via communication interface 116. Sense amplifiers 108 sense data stored in memory cells of memory arrays 106. Controller 104 accesses the stored data by activating one or more rows of memory arrays 106. In one example, the activated rows correspond to a page of stored data.

When a row of memory array 106 is activated, data can be read from the row as part of a read or other operation (e.g., scrubbing for ECS operations, wear leveling). Error correction circuitry 110 is used to detect and correct any errors identified in the accessed data on the row for a read requested by host device 101. Corrected read data is provided for output on communication interface 116 by I/O circuitry 114.

In one embodiment, communication interface (I/F) 116 is a bi-directional parallel or serial communication interface. The host device 101 can include a host processor (e.g., a host central processing unit (CPU) or other processor or processing circuitry, such as a memory management unit (MMU), interface circuitry, etc.).

In one embodiment, memory arrays 106 can be configured in a number of non-volatile memory devices (e.g., dies or LUNs), such as one or more stacked flash memory devices each including non-volatile memory (NVM) having one or more groups of non-volatile memory cells and a local device controller or other periphery circuitry thereon (e.g., device logic, etc.), and controlled by controller 104 over an internal storage-system communication interface (e.g., an Open NAND Flash Interface (ONFI) bus, etc.) separate from the communication interface 116.

In one embodiment, each memory cell in a NOR, NAND, 3D Cross Point, MRAM, or one or more other architecture semiconductor memory array 106 can be programmed individually or collectively to one or a number of programmed states. A single-level cell (SLC) can represent one bit of data per cell in one of two programmed states (e.g., 1 or 0). A multi-level cell (MLC) can represent two or more bits of data per cell in a number of programmed states (e.g., 2n, where n is the number of bits of data). In certain examples, MLC can refer to a memory cell that can store two bits of data in one of 4 programmed states. A triple-level cell (TLC) can represent three bits of data per cell in one of 8 programmed states. A quad-level cell (QLC) can represent four bits of data per cell in one of 16 programmed states. In other examples, MLC can refer to any memory cell that can store more than one bit of data per cell, including TLC and QLC, etc.

The controller 104 can receive instructions from the host device 101, and can transfer data to (e.g., write or erase) or from (e.g., read) one or more of the memory cells of the memory arrays 106. The controller 104 can include, among other things, circuitry or firmware, such as a number of components or integrated circuits. For example, the controller 104 can include one or more memory control units, circuits, or components configured to control access across the memory array and to provide a translation layer between the host device 101 and a storage system, such as a memory manager, one or more memory management tables, etc.

In one embodiment, controller 104 can include circuitry or firmware, such as a number of components or integrated circuits associated with various memory management functions, including, among other functions, error check and scrub, wear leveling, error detection or correction, bank or block retirement, or one or more other memory management functions.

In one embodiment, controller 104 can include a set of management tables configured to maintain various information associated with one or more components of memory device 102 (e.g., various information associated with a memory array or one or more memory cells coupled to controller 104). For example, the management tables can include information regarding bank or block age, block erase count, error history, or one or more error counts (e.g., a write operation error count, a read bit error count, a read operation error count, an erase error count, etc.) for one or more banks or blocks of memory cells coupled to the controller 104. In certain examples, if the number of detected errors for one or more of the error counts is above a threshold, the bit error can be referred to as an uncorrectable bit error. The management tables can maintain a count of correctable or uncorrectable bit errors, among other things.

In one embodiment, memory device 102 can include one or more three-dimensional (e.g., 3D NAND) architecture semiconductor memory arrays 106. The memory arrays 106 can include a number of memory cells arranged in, for example, banks, a number of devices, planes, blocks, physical pages, super blocks, or super pages. As one example, a TLC memory device can include 18,592 bytes (B) of data per page, 1536 pages per block, 548 blocks per plane, and 4 planes per device.

In one embodiment, data can be written to or read from the memory device 102 in pages. However, one or more memory operations (e.g., read, write, erase, etc.) can be performed on larger or smaller groups of memory cells, as desired. For example, a partial update of tagged data from an offload unit can be collected during data migration or garbage collection to ensure it was re-written efficiently.

In one example, a page of data includes a number of bytes of user data (e.g., a data payload) and its corresponding metadata. As an example, a page of data may include 4 KB of user data as well as a number of bytes (e.g., 32B, 54B, 224B, etc.) of auxiliary or metadata corresponding to the user data, such as integrity data (e.g., error detecting or correcting code data), address data (e.g., logical address data, etc.), or other metadata associated with the user data. Different types of memory cells or memory arrays can provide for different page sizes, or may require different amounts of metadata associated therewith.

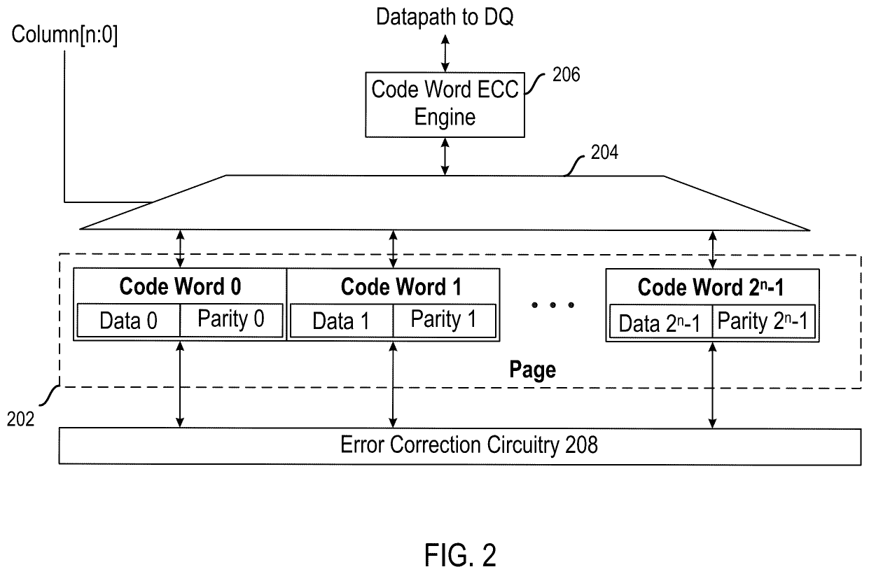

FIG. 2 shows circuitry to correct errors in pages stored in a memory array, in accordance with some embodiments. Code word ECC engine 206 is an example of error correction circuitry 110 and services data for a standard read and write data path of a memory device. Error correction circuitry 208 services memory management operations for data stored in page 202. Error correction circuitry 208 is an example of error correction circuitry 112 and is connected to a bank of a memory bank group. Error correction circuitry 208 receives code words from page 202 using a scrub loop (e.g., 118).

In one example, the page is accessed by activating a row in memory array 106. The error in the accessed page is detected using code word ECC engine 206 or error correction circuitry 208. In one embodiment, one or more parity bits are used to check for errors in the page. Other error detection schemes can be used in other embodiments.

In one example, page 202 contains multiple code words 0, 1, . . . 2n−1. In one embodiment, data stored in the code words of page 202 includes both user data and parity data stored for each code word.

Each page 202 in the memory array has multiple columns [n:0]. Data being read from or written to page 202 is addressed by a row address and a column address. The row address corresponds to a word line that is activated to access data stored in page 202. The column address is used by column decoder 204 to select a column for memory cells containing the data to be accessed.

During a read operation, data read from page 202 is processed by code word ECC engine 206 to detect and correct errors. Corrected data is, for example, communicated to a host device via a data path to input/output pins (e.g., DQ pins).

In one embodiment, each code word of page 202 includes user data (e.g., Data 0) and a parity (e.g., Parity 0) previously calculated for that data. In one example, the parity is an error correction code providing a capability to correct one or more bits of the code word. The parity stored for each code word can be computed by ECC engine 206 when the code word is stored. ECC engine 206 can use the parity stored for each code word to detect and correct one or more bit errors of the code word when the code word is being read.

In one example, when an activate command is issued, page 202 is sensed, and the page's data is stored in sense amplifier latches.

In one example, a memory management operation is allocated to scrub the scrubbed one at a time (e.g., the corrected data is written back into the scrub holding register one code word at a time). Data transfer from the DQ (input/output) pins of the memory device involves use of the code word ECC engine 206 and does not involve the error correction circuitry 208.

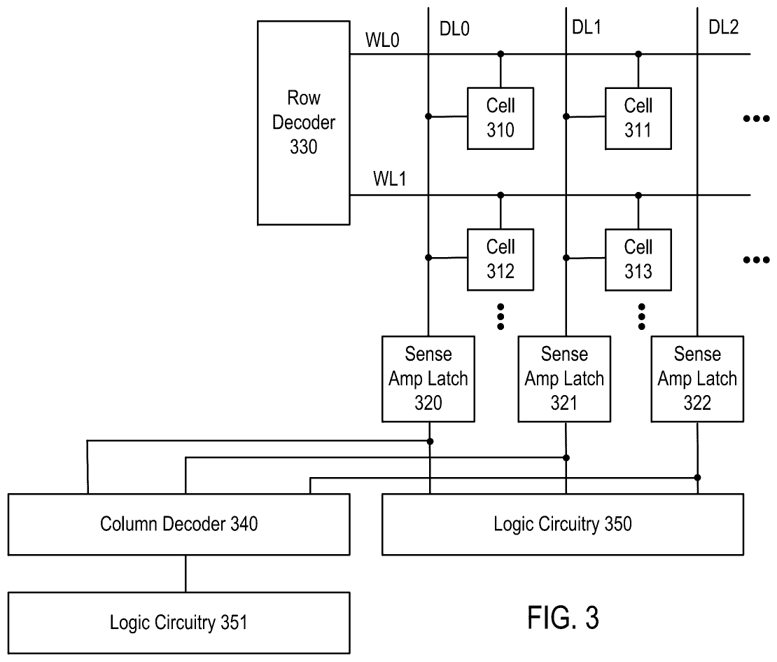

FIG. 3 shows sense amplifier latches 320, 321, 322 to hold data associated with memory cells 310, 311, 312, 313 of a memory array, in accordance with some embodiments. In one example, the memory cells are located in memory array 106. The memory cells can be of various memory types including volatile and/or non-volatile memory cells.

The memory cells are accessed using word lines (e.g., WL0) and digit lines (e.g., DL0) or bit lines. An individual memory cell is accessed by activating a word line selected by row decoder 330 and selecting a digit line or bit line selected by column decoder 340. When a word line is activated, data from each memory cell on a row resides in the corresponding sense amplifier latch for each digit line or bit line.

Data residing in the sense amplifier latches can be used as inputs to logic circuitry 350, 351 for various computations. These can include using parity or other metadata stored with the memory cells to detect and/or correct errors in the data retrieved from the memory cells. In one embodiment, logic circuitry 350 includes error correction circuitry 112. In one example, logic circuitry 350 is arbitrary logic that operates on data at the page level.

Logic circuitry 351 is coupled to column decoder 340. In one embodiment, logic circuitry includes error correction circuitry 110. In one example, logic circuitry 351 is arbitrary logic that operates on data at the column (e.g., code word) level (e.g., ECC engine 206).

In one embodiment, a memory device including a memory array has a plurality of memory cells 310, 311, 312, 313, etc., and one or more circuits or components to provide communication with, or perform one or more memory operations on, the memory array. A single memory array or additional memory arrays, dies, or LUNs can be used. The memory device can include row decoder 330, column decoder 340, sense amplifiers, a page buffer, a selector, an input/output (I/O) circuit, and a controller.

In some non-volatile memory devices (e.g., NAND flash), the memory cells of the memory array can be arranged in blocks. Each block can include sub-blocks. Each sub-block can include a number of physical pages, each page including a number of memory cells. In some examples, the memory cells can be arranged in a number of rows, columns, pages, sub-blocks, blocks, etc., and accessed using, for example, access lines, data lines, or one or more select gates, source lines, etc.

In volatile memory devices (e.g., DRAM) and some emerging non-volatile memory technologies, the memory cells of the memory array can be arranged in banks or other forms of partition. In one example, when an activate to a row address is issued, the row address may be addressed by addressing bits on the activate command using a bank address (to specify which bank within the memory device), and a row address (to specify which row within the specified bank). The word line associated with the row address is brought high.

A controller (e.g., controller 104) can control memory operations of the memory device according to one or more signals or instructions received on control lines (e.g., from host device 101) including, for example, one or more clock signals or control signals that indicate a desired operation (e.g., write, read, erase, etc.), or address signals (A0-AX) received on one or more address lines. One or more devices external to the memory device can control the values of the control signals on the control lines, or the address signals on the address line. Examples of devices external to the memory device can include, but are not limited to, a host, a memory controller, a processor, or one or more circuits or components.

The memory device can use access lines and data lines to transfer data to (e.g., write or erase) or from (e.g., read) one or more of the memory cells. The row decoder and the column decoder can receive and decode the address signals (A0-AX) from the address line, can determine which of the memory cells are to be accessed, and can provide signals to one or more of the access lines (e.g., one or more of a plurality of word lines (e.g., WL0-WLm)) or the data lines (e.g., one or more of a plurality of bit lines (BL0-BLn).

The memory device can include sense circuitry, such as sense amplifiers 108, configured to determine the values of data on (e.g., read), or to determine the values of data to be written to, the memory cells using the data lines. In one example, sense amplifiers are used to sense voltage (e.g., in the case of charge sharing in DRAM). In one example, in selected memory cells, one or more of the sense amplifiers can read a logic level in the selected memory cell in response to a read current flowing in the memory array through the selected cell(s) to the data line(s).

One or more devices external to the memory device can communicate with the memory device using I/O lines (e.g., DQ0-DQN), address lines (e.g., A0-AX), or control lines. I/O circuitry (e.g., 114) can transfer values of data in or out of the memory device, such as in or out of the page buffer or the memory array, using the I/O lines, according to, for example, the control lines and address lines. The page buffer can store data received from the one or more devices external to the memory device before the data is programmed into relevant portions of the memory array, or can store data read from the memory array before the data is transmitted to the one or more devices external to the memory device.

The column decoder 340 can receive and decode address signals (e.g., A0-AX) into one or more column select signals (e.g., CSEL1-CSELn). The selector (e.g., a select circuit) can receive the column select signals (CSEL1-CSELn) and select data in the page buffer representing values of data to be read from or to be programmed into memory cells. Selected data can be transferred between the page buffer and the I/O circuitry.

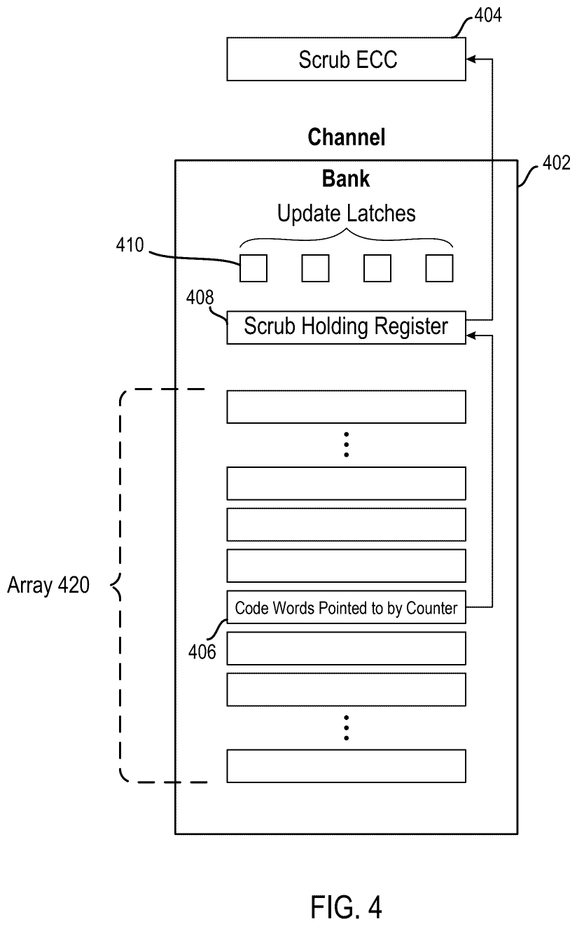

FIG. 4 shows a bank 402 having a scrub holding register 408 that holds data copied from a memory array 420 for scrubbing, in accordance with some embodiments. Scrub ECC engine 404 services bank 402 during scrub operations. ECC engine 404 is coupled to bank 402 by a scrub loop. Bank 402 is an example of a bank in memory array 106. ECC engine 404 is an example of error correction circuitry 112. In one example, ECC engine 404 is connected to bank 402 using scrub loop 118.

Memory array 420 includes various rows of data, as illustrated. In one example, each row includes multiple code words. These rows include row 406 pointed to by an error check and scrub counter (e.g., ECS counter 140). In one example, the multiple code words of the row correspond to a source page of data.

The code word granularity of the counter (e.g., ECS counter 140) may vary. In some cases the granularity of the counter could be a single code word (e.g., a portion of a page). In other cases the granularity of the counter could be a plurality of code words (e.g., where the granularity of the counter is one page). In general, the following relations can be made: the granularity of the ECS counter (e.g., the quantity of code words pointed to by each ECS counter value)=the number of update latches=the number of code words stored by the holding register =the number of code words transferred/received from the scrub ECC engine.

Scrub holding register 408 is an example of temporary storage 120. In response to a first memory management command received by a controller, data is copied from row 406 (e.g., a source page or data) to scrub holding register 408. Code words are sent from scrub holding register 408 to ECC engine 404 for scrubbing.

In one example, a first memory management command is received. Generally, the first memory management command can be any command resulting in an operation that includes an ECC scrub. In response to receiving the first memory management command, source data is moved to the scrub holding register 408. Update latches 410 are reset LOW. Multiplexing of source data in scrub holding register 408 to ECC engine 404 via a scrub loop is started. This process continues in the background after the first memory management command has been received.

After the first memory management command (e.g., RFM, Refresh, ECS command) is received, data is read and written from various rows of array 420 while scrubbing is being performed in the background, as described above. These rows can include row 406, for which data is being scrubbed in the background.

In one example, the scrub holding register is a set of CMOS latches. In one example, the scrub holding register is an extra row in the memory array 420 (but the extra row is not addressable by an activate command).

In various embodiments, a first ECS operation may be triggered automatically or manually (e.g., by the first memory management command above). In one example, as part of the first ECS operation, appropriate data is moved (e.g., as pointed to by the ECS counter) to the scrub holding register 408. Update latches 410 are reset low. The number of update latches 410 used is dependent upon the number of code words transferred to the scrub holding register 408.

A controller starts multiplexing source data in scrub holding register 408 to scrub ECC engine 404 via a scrub loop (e.g., 118). This scrubbing process continues in the background even after the time period allocated to the first ECS operation has ended. After the first ECS operation has ended, if the appropriate address is given, data may be read and written from an array location pointed to by the ECS counter.

In one embodiment, a non-volatile RAM includes a code word ECS counter that increments through an entire memory array. In one example, the set of code words pointed to by the ECS counter can be code words that exist in multiple banks. A first ECS operation is triggered by a refresh command that is stolen. Two ECS operations are used to perform a scrub: the first operation is used to transfer the data to a scrub holding register. The second ECS operation is used to transfer the scrubbed data from the scrub holding register back to the memory array location(s) s pointed to by the ECS counter.

As density increases for DRAM devices, the time for refresh (tRFC) also increases. In some cases, this increased refresh time permits using a larger time period for each ECS operation. In one embodiment, two or more rows can be opened in a single ECS operation. A first row can be opened to replace scrubbed data (move data from scrub holding register to the array) from a prior ECS operation. The first row can be closed, and then a second row opened to transfer data to the scrub holding register. Then the second row can be closed. So, on average a memory device can perform an ECS scrub of data (e.g., one or more code words) in a row for each refresh command that is stolen.

As mentioned above, an ECS operation may be triggered by two methods: automatically or manually. Both ECS trigger methods ensure that the entire array (e.g., all data within a DRAM device) experiences an ECS operation every certain full scrub period.

In one example, a full scrub period is 24 hours and each ECS operation services one row consisting of one or more code words. That is, every 24 hours (full scrub period) all data (or all code words) within a DRAM device experiences an ECS operation. Therefore, to determine the average periodic interval per ECS operation to ensure that the full scrub period is met, the following may be asserted: 24 hours×60 minutes×60 seconds=86,400 seconds. The following can be defined: tECSint (average periodic interval per ECS operation)=86,400 seconds/(rows per DRAM).

This is an advantage in that conventionally one refresh command must be stolen per code word, whereas here a full row is transferred to the holding register at a time to be scrubbed in the background and replaced later. Then only (1/code words per row) refreshes need to be stolen with two activates in long tRFC or (2/code words per row) for short tRFC single activation ECS operation. For example, with a common 6 column address specification, this is a 64X or 32X improvement.

In general, the number of code words per ECS counter value equals the number of code words scrubbed per ECS operation. The case of scrubbing one code word per ECS operation is described above, but other variations are possible. Generally, any number of code words can be scrubbed per ECS operation. In one example, only one code word is scrubbed per ECS operation. More generally, a plurality of code words can be scrubbed per stolen refresh command (e.g., ECS operation).

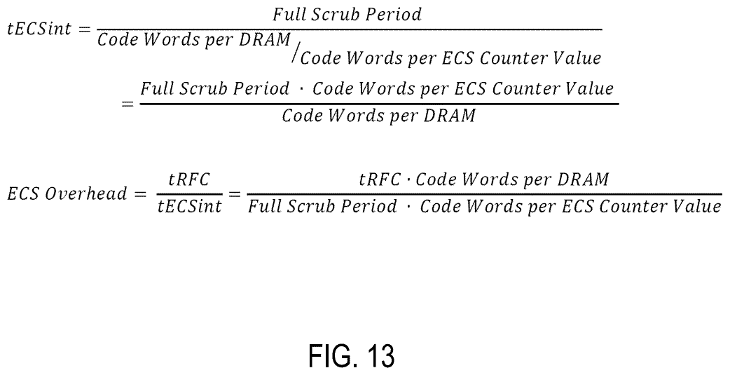

FIG. 13 shows equations for generally determining tECSint and ECS overhead, in accordance with some embodiments. In the equation for ECS overhead, tRFC is the refresh cycle time. The ECS operation duration is less than the refresh cycle time because a refresh cycle is stolen to perform the ECS operation.

As illustrated, the number of “Code Words per ECS Counter Value” is inversely proportional to the ECS Overhead. Therefore, ECS overhead may be improved by increasing the number of “Code Words per ECS Counter Value”. The number of “Code Words per ECS Counter Value” is related to number of code words scrubbed per ECS operation.

On average every tECSint, an ECS operation is triggered either automatically or manually. Under the automatic trigger method, a refresh command issued by a controller is stolen by the DRAM device to trigger an ECS operation. From the perspective of the controller (e.g., located outside the DRAM device), the controller is simply issuing refresh commands according to the specified refresh interval (tREFI). The DRAM device implicitly, at tECSint, uses a refresh command from the controller to trigger an ECS operation. Under the automatic trigger method, the DRAM device has the responsibility to steal refresh commands at the appropriate frequency to trigger ECS operations and meet the required tECSint.

For the automatic trigger method, the tECSint is measured by the DRAM device. For example, the DRAM device can use a trimmed oscillator and counter to generate a signal every tECSint, which results in a refresh operation being stolen for an ECS operation.

In an alternative example, the DRAM device can count refresh commands to produce a tECSint measurement. Counting refresh commands is valid because refresh is issued by the controller at a certain specified time interval (tREFI). Thus, tECSint can be determined based on the following number of refresh commands: Number of Refresh Commands per tECSint=tECSint/tREFI.

When using the manual trigger method, on average every tECSint a controller issues a special command (e.g., multi-purpose command with certain op code) to trigger an ECS operation. The controller is responsible to issue an ECS operation every tECSint and a refresh command every tREFI. The controller in this case (not the DRAM device) measures tECSint. The controller has a timer used to schedule refresh commands. In one example, the controller adds an additional tECSint timer, or counts issued refresh commands to schedule the issuing of an ECS operation every tECSint.

The automatic and manual ECS approaches above can trigger the same ECS operation. Automatic ECS triggering uses less controller overhead as the controller is not burdened with measuring tECSint. However, in some circumstances, it may be advantageous for the controller to have the flexibility to schedule ECS operations directly. In such circumstances, manual ECS triggering can be used.

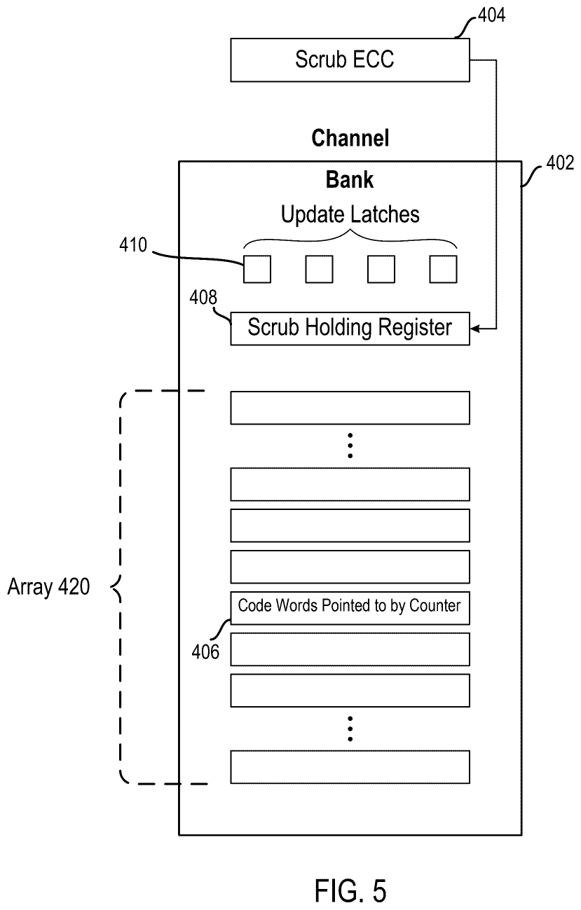

FIG. 5 shows the bank 402 of FIG. 4 during scrub operations using ECC engine 404, in accordance with some embodiments. Code words from scrub holding register 408 are scrubbed by ECC engine 404 in the background while read and write operations are occurring in the same bank or other banks. Scrubbed code words are returned to scrub holding register 408.

In one embodiment, one code word at a time is sent to ECC engine 404 using a scrub loop. The scrub loop is shared with multiple banks 402 that are in the same memory management group.

While code words from scrub holding register 408 are being scrubbed, writes can occur to various rows or pages in bank 402. In the case of a write operation that occurs to an address in the row 406, the state of memory cells storing data for one or more code words in row 406 is changed. Update latches 410 each correspond to one of the code words in row 406. The state of each latch 410 is changed to indicate whether a particular corresponding code word has been written to in row 406 during the background scrubbing. In one example, status data 130 is provided by the states of the update latches 410.

In one example, after receiving a first memory management command (e.g., a command that manually triggers an ECS operation), but before receiving a second memory management command (between the first and second memory management commands), if a write command occurs to a column, the respective update latch for that column is set HIGH. At some time after the first memory management command is received, scrubbed source data arrives to the bank and is loaded into the scrub holding register.

The second memory management command occurs after scrubbed source data has been loaded into the scrub holding register. In one example, memory management command timing (e.g., tMM2MM specification) is set to ensure that memory management commands are appropriately and sufficiently spaced so that scrubbing has been completed.

In one example, a write command occurs to a column (e.g., code word), and the respective update latch for that column is set HIGH. Sometime after a first ECS operation, scrubbed data arrives to bank 402 and is loaded into the scrub holding register 408. Data may be read and written from the array 420 location pointed to by the ECS counter while updating the update latches 410 appropriately.

A second ECS operation is set to occur safely after the scrubbed source data has been loaded into the scrub holding register 408. For example, a time spacing between ECS operations (tECS2ECS specification) is set to ensure that ECS operations are appropriately spaced.

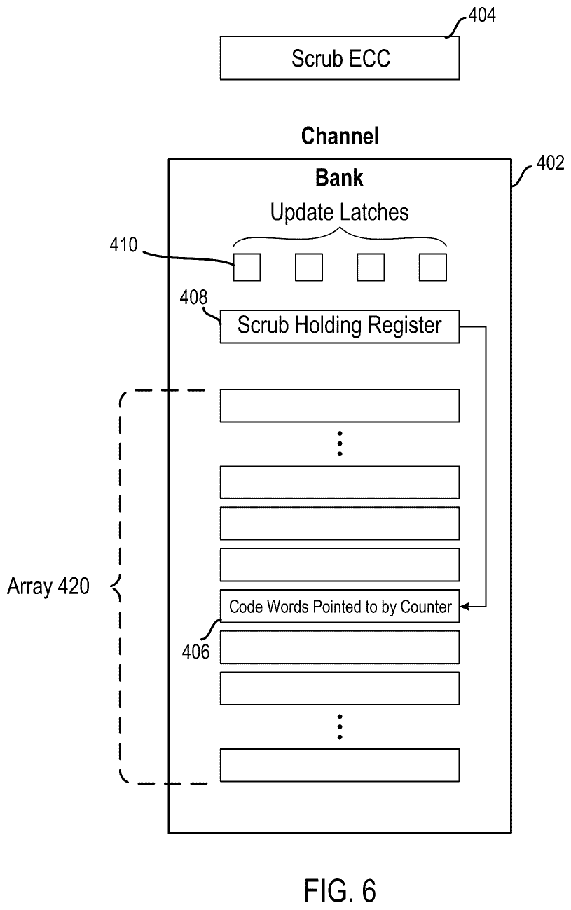

FIG. 6 shows the transfer during a second scrub operation of scrubbed data back to the address in the bank 402 of FIG. 4 from which the data was copied in a first scrub operation, in accordance with some embodiments. After scrubbing of data in the scrub holding register 408 is complete, a second ECS operation is triggered (e.g., a controller receives a second memory management command, or a controller automatically triggers the second ECS operation).

In the second ECS operation, selected portions (or all) of scrubbed data from the scrub holding register 408 is transferred back to row 406. The data to transfer back is selected as determined by status data 130 (e.g., the states stored in update latches 410). Update latches 410 indicate those columns to which new data has been written during scrubbing. For these columns, data is not transferred back.

Update latches 410 indicate other columns for which no data has been written during scrubbing. For these other columns, scrubbed code words corresponding to the columns where no write has occurred are transferred from scrub holding register 408 back to row 406.

In one embodiment, the ECS counter is only updated after the second ECS operation. Thus, the ECS counter is updated every two ECS operations. One ECS operation moves data from the array for scrubbing, and another ECS operation moves the scrubbed data back to the array.

In one embodiment, a controller may determine that no writes have occurred to a row to which the ECS counter is pointed. In such case, the controller does not need to use the update latches and can directly write back all code words from the scrub holding register to the array.

In one example, during a second ECS operation, for each column (code word), if the corresponding update latch is HIGH (a WRITE to column has occurred since the first ECS operation), the data in the array is maintained. Otherwise, if the update latch is LOW (no WRITE to column has occurred since the first ECS operation), scrubbed source data is moved from scrub holding register 408 to row 406.

In one example, in response to receiving a second memory management command (e.g., that triggers an ECS operation), for each column (code word):
If update latch is HIGH (e.g., a WRITE to column has occurred since the first memory management command), no data is moved for that column.
Else if update latch is LOW (e.g., no WRITE to column has occurred since the first memory management command), move scrubbed source data from scrub holding register back to source location (e.g., row).

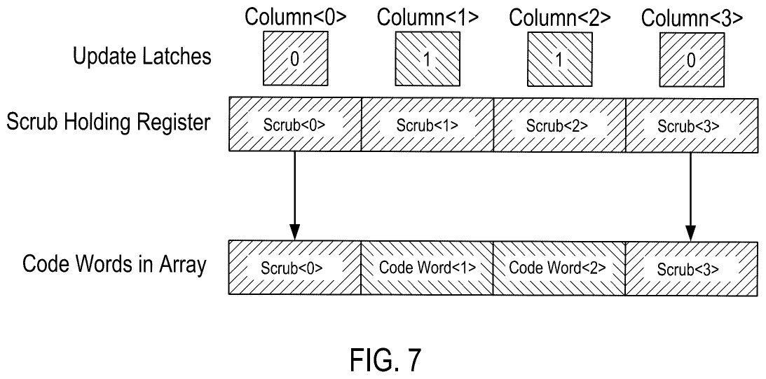

FIG. 7 shows a non-limiting example of the transfer of scrubbed data back to a memory array (e.g., back to row 406 of FIG. 6) based on a state of update latches (e.g., 410), in accordance with some embodiments. The state (e.g., LOW or HIGH) of each update latch determines whether or not array contents are overwritten by the corresponding contents of the scrub holding register (e.g., 408).

The update latches are set either low or high, as indicated by 0 or 1. This is done for each column of the source location (e.g., row or page). Each column corresponds to a code word of the row or page. If an update latch is set low for a code word, then data for that code word is copied from the scrub holding register back to the source location (e.g., row or page). If an update latch is set high for a code word, then that code word is not copied and there is no change to the source location (e.g., row or page) for that code word.

If the update latch is set high for a code word, that is an indication that the corresponding code word was written to during the scrubbing of the code word by the ECC engine. Thus, the scrub holding register writes back to the array according the state of the update latches.

In one example, as illustrated in FIG. 7, code words in the array are pointed to by an ECS counter. The scrub holding register stores code words that have been scrubbed in the background in between first and second ECS operations. Due to no write having occurred (in between the first and second ECS operations), the array contents associated with Column<0> and Column<3> are overwritten by the code words Scrub<0> and Scrub<3>. Due to a write occurring (in between the first and second ECS operations) to the array contents of Column<1> and Column<2>, the appropriate code words (Code Word<1> and Code Word<2>) are not overwritten, but instead maintained and unchanged.

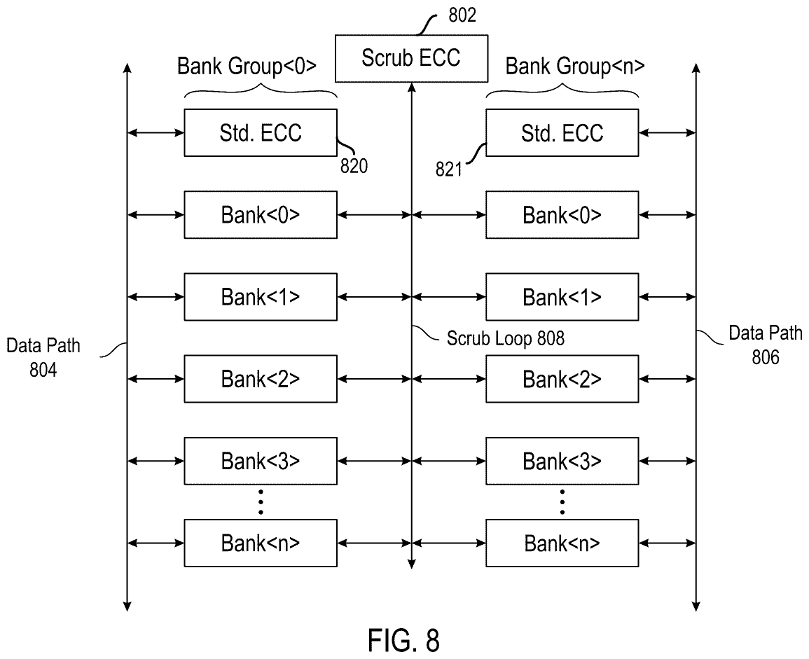

FIG. 8 shows a data path 804, 806 for read and write operations for a host device (e.g., 101) and a scrub loop 808 shared by multiple banks for servicing scrubbing operations, in accordance with some embodiments. Scrub ECC engine 802 scrubs data sent from various banks using scrub loop 808. The banks can be arranged in bank groups. The ECC engine 802 can service one or both bank groups for any given operation or time interval.

It should be noted that, in general, any number of banks or bank groups may be serviced by the scrub ECC engine. For example, all banks of the memory device could be serviced by a scrub ECC engine. FIG. 8 shows a specific case corresponding to an embodiment in which: each bank group can share it's own standard ECC engine, and a scrub ECC engine is shared amongst any number “n” of bank groups (indicated by “Bank Group <n>”).

As mentioned above, the need for a scrub ECC engine occurs when each bank is not associated with its own Std. ECC engine due to the possibility of data collisions. However, the use of both a scrub loop engine and scrub ECC engine as described herein may be done even when every bank is associated with it's own ECC engine. For example, in some cases this may enable scrubbing an increased number of code words per ECS operation. Therefore, in some embodiments every bank may be associated with it's own Std. ECC engine and a multiplicity (singular or plural) of scrub ECC engines may be associated with some set of banks.

In one embodiment, a bank is divided into sub-banks. The bank is associated with a Std. ECC engine. Therefore, a plurality of sub-banks share a Std. ECC engine. An activate command may trigger an activate operation in one sub-bank and a concurrent ECS operation in another sub-bank. There would be data conflicts if the Std. ECC engine associated with the bank services both the activate (e.g., during reads and write operations of the activated row) and the ECS operation (e.g., scrub of a multiplicity of code words) at the same time. Therefore, this approach can be applied to resolve data conflicts.

Each sub-bank may be associated with it's own holding register and update latches. An activate command may trigger an activate operation in one sub-bank and a concurrent ECS operation in another sub-bank. The Std. ECC engine may service reads and writes of the row activated by the activate operation. The holding register, update latches, scrub loop, and a scrub ECC engine may service the ECS operation that occurs in the other sub-bank.

In some embodiments, to reduce total scrub time (thereby reducing tMM2MM), there may be multiple scrub ECC engines that exist on the memory device to allow multiple banks to be scrubbed in parallel. For example, a memory device may contain four bank groups, four standard (Std.) ECC engines, and two scrub ECC engines. In this case, each bank group is associated with it's own standard ECC engine, and a set of two bank groups is associated with it's own scrub ECC engine. A memory management group may contain a subset of banks that may exist across one or more bank groups. In some cases, the memory management group may encompass all banks across the die (e.g., an all-bank memory management operation).

In general, a greater number of scrub ECC engines results in reduced scrub time (related to tMM2MM). Reduced scrub time is associated with reduced system impact and command scheduling issues. However, a greater number of scrub ECC engines result in additional die size. Thus, there is a tradeoff between scrub time and die size.

Scrub loop 808 is an example of scrub loop 118. Scrub ECC engine 802 is an example of error correction circuitry 112. Data path 804, 806 is an example of a data path including I/O circuitry 114 and communication interface 116.

In one embodiment, each bank group has an associated standard ECC engine 820, 821. ECC engines 820, 821 service read and write operations on data paths 804, 806. ECC engines 820, 821 are an example of error correction circuitry 110.

In one example of a DRAM device, each bank group contains its own ECC engine at the edge of the bank group. This ECC engine operates during standard read and write commands. An additional scrub ECC engine is added in channel to facilitate ECC scrubbing during ECS operations. Scrub loop 808 is a serial transmission loop added to allow background communication between banks and the scrub ECC engine.

Each bank includes a scrub holding register to store contents of a set of code words (pointed to by ECS counter) for transmission to the scrub ECC engine. Alternatively, scrub holding registers could be shared by multiple banks (e.g., a pair of banks) or there may be multiple scrub holding registers per bank (e.g., a pair of holding registers per bank). The scrub holding register receives and stores scrubbed code words from the scrub ECC engine. Similarly, update latches could be shared by multiple banks (e.g., a pair of banks) or there may be multiple sets of update latches per bank.

A number of update latches are used that is dependent upon the number of code words transferred to/from the scrub holding register. These update latches track which columns have been written to since the first ECS operation. Scrubbed row data is formed by combining data from the scrub holding register with the array contents. The specific combination is dependent upon the state of the update latches.

In one example, ECS to ECS operation spacing (tECS2ECS) is set to be greater than the elapsed time between all banks in a set of banks sending data to be scrubbed and then all banks in a set of banks receiving scrubbed data. In one example, the scrub loop consists of a bi-directional bus from the banks to/from the scrub ECC engine, or uni-directional buses from the banks to/from the scrub ECC engine.

In one example, ECS to ECS operation spacing is set to be less than or equal to the ECS interval (e.g., tECSint). The ECS to ECS operation spacing can be greater than tRFC because scrubbing of the scrub holding register is done in the background.

Advantages of using the scrub loop include that the standard data path is not disturbed. The standard ECC engines services reads and writes, while the scrub ECC engine(s) services ECC scrubbing in the background. Accesses to the memory array to move data from the array or write data back to the array occur during one or more of the ECS operations.

In some cases, due to ECC correction occurring in the background (e.g., in between ECS operations as described above), the ECS operation duration (e.g., tRFC or refresh cycle time) may allow multiple code words to be transferred to/from the scrub holding register (e.g., 408). Traditionally, a read, modify (correction), and write of one code word has occurred within tRFC. However, using background scrubbing as described herein, a read (transfer of data from the array to the scrub holding register) or write (transfer of data from the scrub holding register to the array) only occurs during the ECS operation itself, while the correction occurs in the background in between two ECS operations.

As a result, the correction time (e.g., scrub ECC engine latency) can be partially or fully removed from the tRFC budget used for operating a memory device. Because only a read or write occurs during tRFC, more time is provided to read/write a greater number of code words. Therefore, in some embodiments, multiple code words can be scrubbed for each ECS operation. In contrast, traditionally only one code word is scrubbed for each ECS operation.

In one example, using embodiments for background scrubbing as described herein, two ECS operations are used to complete a complete scrub operation (e.g., first ECS operation and second ECS operation). Thus, transferring two code words at a time can provide identical scrub efficiency as for traditional ECS not using background scrubbing. Thus, an advantage may be realized by transferring more than two code words per ECS operation. This may reduce ECS overhead (e.g., less stolen refresh cycles used for ECS).

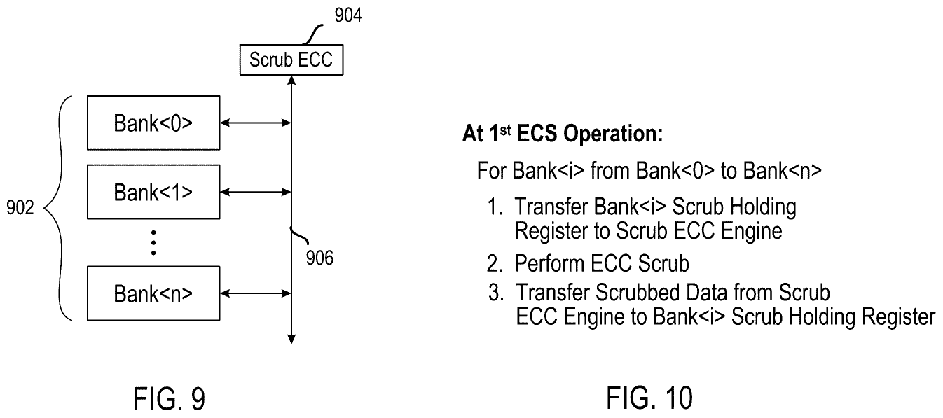

FIG. 9 shows banks of a memory management group 902 (e.g., a refresh group used for ECS) coupled to a scrub ECC engine 904, in accordance with some embodiments. Portions of data from each bank are sent to ECC engine 904 for scrubbing using scrub loop 906. Scrub loop 906 is a separate data path from the data path used for read and write operations, such as described above.

It should be noted that the embodiment depicted by FIG. 9 is a first case that assumes each memory management group is associated with it's own scrub ECC engine. In this case, multiple memory management commands (to different memory management groups) could occur in parallel. However, the appropriate tMM2MM value elapses before a memory management command occurs to the same management group.

However, in some embodiments for a second case, a scrub ECC engine may be associated with a plurality of memory management groups. In this case, the tMM2MM (for a set of memory management groups) value may be increased. In this case, a memory management command could not be issued to a set of memory management groups that share the same scrub ECC engine until the appropriate tMM2MM value elapses.

In a third case, in some embodiments, a scrub ECC engine may be associated with a subset of a memory management group (e.g., half of the banks associated with a memory management group). In this case, the scrub operation may occur for subsets of the memory management group in parallel to reduce the scrub time and thereby reduce the tMM2MM (for the same memory management group) specification. Also, in this case, multiple memory management commands (to different memory management groups) could occur in parallel like the case in which each memory management group is associated with one scrub ECC engine (as described for the first case above).

FIG. 10 shows a process for scrubbing multiple banks in a memory management group, in accordance with some embodiments. In one example, the banks are in a refresh group (e.g., 902). When a first memory management command is received (e.g., an ECS operation is triggered), then source read data for each bank is transferred from a scrub holding register to scrub ECC engine 904. After the scrub is performed, the scrubbed source data is transferred from scrub ECC engine 904 back to the scrub holding register. Source data to be scrubbed generally refers to a set of code words pointed to by the ECS counter. In one example, the source data may be an entire row (referred to herein as a source row). However, the source data may not necessarily be associated with an entire row, but only some lesser number of code words selected from a row.

It should be noted that FIG. 10 corresponds to the first and second cases described above for FIG. 9. However, for the third case for FIG. 9 above, a plurality of the illustrated “for loops” can be running in parallel. In this case, each “for loop” scrubs a unique subset (of banks) of the memory management group.

In one embodiment, a DRAM device shares a scrub ECC engine across multiple banks for the purpose of facilitating ECC scrubs. A scrub holding register is used for each bank. The holding register stores the contents of a plurality of code words pointed to by an ECS counter for transmission to the shared scrub ECC engine, and stores scrubbed data received from the scrub ECC engine.

In between ECS operations, user data (e.g., for a host device) may be read and written from the array location pointed to by the ECS counter while updating update latches appropriately (e.g., as described above). The number of update latches can correspond to the number of code words transferred to/from the scrub holding register.

The resulting scrubbed data is composed of a combination of code words that exist in the scrub holding register and the array, where the specific combination is dependent upon the state of the update latches.

In one embodiment, the above ECC scrubs may be a part of a systematic and periodic scrub routine which scrubs all code words that exist on the DRAM die. The above approach allows scrubbing of the array to be concurrent to normal DRAM operation. The ECS counter cycles through all code words of the entire die every certain time interval.

In some examples, data transfer may occur simultaneously from the bank to the shared ECC engine and from the ECC engine to the bank.

In some examples, in addition to transmitting scrubbed source data to the bank, the scrub ECC engine may also send additional information to the bank concerning any possible errors (e.g., no error, single-bit error, multiple-bit error, or uncorrectable error). Based upon the reception of this information, the bank may determine to perform some control or other operational action.

In one embodiment, use of a separate scrub ECC engine as described herein frees up the main data bus so that reads and writes can occur to other banks during a maintenance mode cycle. The standard ECC engine is always available to handle reads and writes. It does not handle the scrubbing.

In one example, there is an update latch for each code word that exists in a page. There can be any number of pages in the refresh group (or other pool). The scrub holding register, and update latches are shared by all pages in the group or pool.

In one embodiment, the standard data bus used for read and write operations is wider than the database used for the scrub loop. This is done so that reads and writes can occur quickly. The data bus from the scrub holding register to the ECC engine is narrower than the standard data bus (scrub loop is the narrower data path). After the scrub of each code word, it is returned to the scrub holding register. This occurs in the background for all the banks in a refresh or other memory management group.

In one embodiment, data can be accessed within the refresh group through activates (e.g., a controller can read and write that data). In one example, a logical address is issued to a particular bank, and the corresponding physical address points to the source location (e.g., row). In this example, the ECS counter value address space is coincidentally associated with the address space of an activate. The address space may be activated despite the data associated with the ECS counter value address space undergoing a scrub.

In one embodiment, in the background between the first and second memory management commands, data is being scrubbed and then sent back to the scrub holding register. A read or write can occur during this time to the source page. If there is a read, the data is sent on the standard data bus up to the ECC engine at the bank group edge. If there is a write, parity is generated for the incoming data by the ECC engine. Note that the scrub holding register data is not updated by the write commands.

For example, if code word 0 is written, then the update latch for code word 0 is set high. If the update latch is high, that means the particular code word was written to while the scrub was occurring. The memory specification is set to allow enough time for all banks to be scrubbed using the narrower bus of the scrub loop before the second memory management command is received.

In one example, each page of a bank consists of code words or columns. The second memory management command has been issued to a particular bank. The page is the set of specific memory cells that are activated when an activate command is issued. An activate command has a bank address as well as a row address.

In one embodiment, each bank group is coupled to a particular data path for that bank group. One or more bank groups are associated with a scrub ECC engine. The scrub loop is typically a smaller data path to minimize die area. In one example, a narrower data path transfers a smaller number of bits in a given time than the standard data path. In one example, a standard data path is 100 bits wide and a scrub loop is 10 bits wide.

In one example, a particular memory die may have many memory management groups. A memory management command is issued to a specific memory management group. This causes a memory management operation to occur for all banks in the group. The group is coupled to the scrub ECC engine. A controller iterates through each bank in the group.

In one embodiment, the standard data bus for a memory device is a bi-directional bus. The scrub loop of the memory device is either a bi-directional or uni-directional bus.

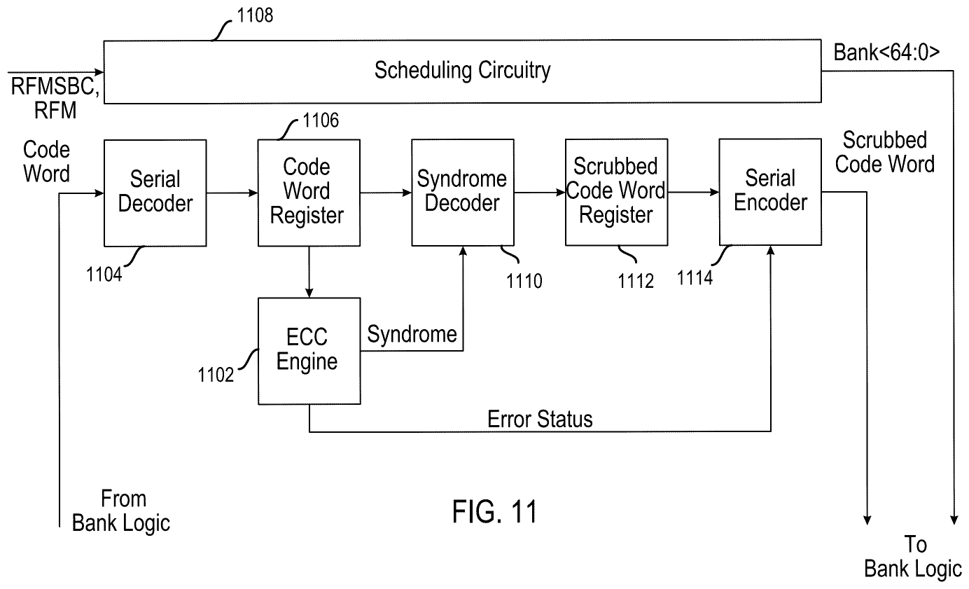

FIG. 11 shows error correction circuitry (e.g., error correction circuitry 112) for scrubbing code words from a bank of a memory array, in accordance with some embodiments. In one example, the code words are received from bank 402.

Scheduling circuitry 1108 receives signals from a controller. One of the signals is a first memory management command (e.g., RFM). Another signal is a signal that indicates a grouping of banks and/or bank groups to use for memory management operations. Another signal is a signal provided from a mode register setting that sets the granularity of the memory management group or bank size (e.g., RFMSBC).

Scheduling circuitry 1108 sends signals to logic circuitry of one or more banks to control transfer of code words from each bank to serial decoder 1104.

In one example, eight banks are run in parallel for scrubbing (e.g., ECS). The scrub time of one bank is proportional to the bus width of the scrub ECC engine that services the bank.

In one embodiment, serial decoder 1104 receives one code word at a time from each bank. The code word is decoded by serial decoder 1104 and stored in code word register 1106. ECC engine 1102 generates a syndrome for the code word as an output. The syndrome is decoded by syndrome decoder 1110, and a scrubbed code word is provided as output and stored in register 1112. The scrubbed code word is encoded by serial encoder 1114 and transferred back to the bank that sent the code word.

When performing error detection and/or correction on each code word, ECC engine 1102 generates various signals (illustrated as “Error Status”) indicating a state or status from processing the code word. In one embodiment, the signal is an uncorrectable error alert that indicates the code word contains one or more uncorrectable errors. One or more of these signals are provided to serial encoder 1114, which encodes the signals for sending to the bank to which the code word is returned. The signal can be used by a controller to modify operations of the memory device.

In one embodiment, transmission of the scrubbed code word to the bank logic and transmission of the next code word from the bank logic may occur simultaneously. In one embodiment, the memory device is nonvolatile, but the holding registers are volatile (e.g., CMOS) registers. If power is lost while scrub is occurring in the background, data can be lost if not already transferred to the memory array. The write data might be in a volatile holding register. In one example, if power is detected as being lost, a controller uses available capacitance to transfer the data.

In one embodiment, bank logic or a controller performs one or more arbitrary actions based on a signal from the ECC engine. In one example, a bank-level arbitrary action may occur upon the bank receiving an “Error Status” from the scrub ECC engine.

An uncorrectable physical defect (e.g., 4 or 5 bits stuck low), cannot be corrected because the number of errors exceed the correction capabilities of the scrub ECC engine. Thus, in the event of an uncorrectable error, the scrub ECC engine detects that there is an uncorrectable error, but does not attempt to correct the data. In this case, the data remains unchanged with the uncorrectable error still existing in the scrub holding register.

In one example, the ECC engine detects that there is an uncorrectable error. The ECC engine can identify that there is uncorrectable data in the source data (e.g., a source row).

In one embodiment, the scrub ECC circuitry uses two uni-directional buses for connecting to the appropriate banks. Code words are transmitted on a data bus and this information is decoded using the serial decoder. A code word register is populated. The ECC engine computes parity and compares the computed parity to the stored parity to produce a syndrome. A syndrome decode occurs which may cause some bits to flip to correct the code word.

The error status signal(s) generated by ECC engine 1102 may consist, for example, of the following cases for which data can be communicated to the bank logic:
[Case 1] No errors
[Case 2] Error detected and corrected.
[Case 3] Two errors detected and corrected
[Case 4] Uncorrectable error

It should be noted that this pattern can be reduced or extended to cover an ECC engine of any error detection and correction capability.

For the case of an uncorrectable error (e.g., case 4), the ECC engine is unable to provide any correction. Thus, the uncorrectable error cannot be corrected (e.g., scrubbed). In this case, the ECC engine may decide to send the same data it received back to the bank logic. Alternatively, the ECC engine may not send any data to the bank logic due to the scrub holding register requiring no update. Whether or not the ECC engine sends the uncorrected data back to the bank logic, the ECC engine may send the error status back to the bank logic.

When the bank logic receives the error status, some action may occur. The exact number of errors (e.g., case 2, case 3, or case 4) is dependent upon process/yield capability.

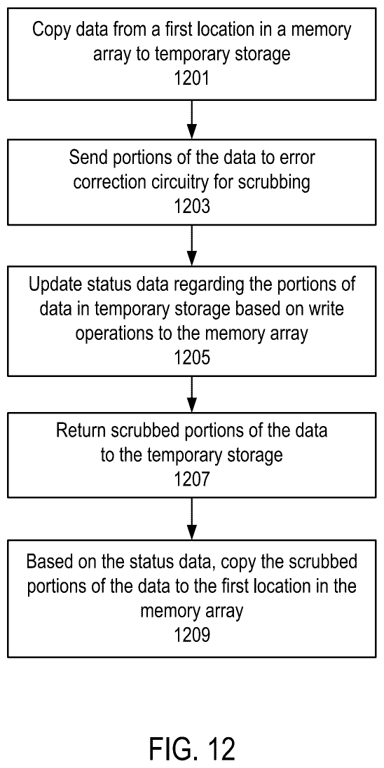

FIG. 12 shows a method for scrubbing data in a memory array using temporary storage, in accordance with some embodiments. For example, the method of FIG. 12 can be implemented in the memory device 102 of FIG. 1. In one example, data from a row (pointed to by an ECS counter) in the memory array 106 is moved to temporary storage 120. The moved data is transmitted to error correction circuitry 112 using scrub loop 118. Writes that occur to the address of the row pointed to by the ECS counter during scrubbing are recorded as status data 130. After scrubbing is complete, the scrubbed data is moved to back to the row pointed to by the ECS counter. The portion of the scrubbed data moved to the target page is determined based on any writes that occurred as indicated by status data 130.

The method of FIG. 12 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method of FIG. 12 is performed at least in part by one or more processing devices (e.g., controller 104 of FIG. 1) and/or by logic circuitry.

Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At block 1201, data is copied from a first location in a memory array to temporary storage. In one example, the temporary storage is scrub holding register 408. In one example, the first location is a row(s) pointed to by an ECS counter.

At block 1203, portions of the data are sent to error correction circuitry for scrubbing. In one example, the error correction circuitry is scrub ECC engine 404.

At block 1205, status data is updated regarding the portions of data in temporary storage based on write operations to the memory array. In one example, update latches 410 are set to indicate write operations that occur to the first location in the array during scrubbing.

At block 1207, scrubbed portions of the data are returned to the temporary storage from the error correction circuitry. In one example, scrubbed code words are returned to scrub holding register 408.

At block 1209, the scrubbed portions of the data are copied to the first location based on the status data. For example, data stored in a DRAM is scrubbed and returned to the same address location. For example, data from a source page is scrubbed and then copied back to the same location in the array. In one example, scrubbed code words are copied to row 406 based on the states of update latches 410 (e.g., data is selected to write back to the array as illustrated in FIG. 7).

In some aspects, the techniques described herein relate to an apparatus including: a register (e.g., scrub holding register 408); and at least one controller configured to: move data stored at an address in a memory array (e.g., source page) to the register; scrub the data in the register to provide scrubbed data; and write at least a portion of the scrubbed data to the address in the memory array (e.g., overwrite data stored in the source page).

In some aspects, the techniques described herein relate to an apparatus, wherein an error check and scrub (ECS) counter (e.g., 140) points to the address in the memory array, and the controller is configured to increment the ECS counter after writing the portion of the scrubbed data to the address.

In some aspects, the techniques described herein relate to an apparatus,

wherein the data moved to the register is a source page (e.g., 202) stored in the memory array, and writing the scrubbed data to the address includes overwriting at least a portion of the source page in the memory array.

In some aspects, the techniques described herein relate to an apparatus, wherein the controller is further configured to write new data to the address in the memory array while the data in the register is being scrubbed.

In some aspects, the techniques described herein relate to an apparatus,

wherein the data stored at the address is first data, and writing the scrubbed data to the address includes overwriting only that portion of the first data not changed by writing the new data (e.g., overwriting based on state of update latches 410).

In some aspects, the techniques described herein relate to an apparatus, wherein a first error check and scrub (ECS) operation is triggered by issuance of a first memory management command, and the data is moved during the first ECS operation.

In some aspects, the techniques described herein relate to an apparatus, wherein a second ECS operation is triggered by issuance of a second memory management command, and the portion of the scrubbed data is written to the address during the second ECS operation.

In some aspects, the techniques described herein relate to an apparatus including: a plurality of latches (e.g., update latches 410); at least one memory array (e.g., 106); and at least one controller (e.g., 104) configured to: scrub first data stored in the memory array to provide scrubbed data; update the latches based on a write operation that occurs while scrubbing the first data; and overwrite, using the scrubbed data and based on a state of the updated latches, at least a portion of the first data.

In some aspects, the techniques described herein relate to an apparatus, wherein the memory array is configured in a volatile memory device, and the first data is scrubbed as part of an error check and scrub (ECS) operation.

In some aspects, the techniques described herein relate to an apparatus, wherein the write operation causes a change to the first data in the memory array (e.g., a new code word is written to a page).

In some aspects, the techniques described herein relate to an apparatus, wherein each of the latches corresponds to a code word.

In some aspects, the techniques described herein relate to an apparatus, wherein each latch corresponds to a respective code word of the first data, and each latch is configured to indicate whether the respective code word has been written during the write operation (e.g., as illustrated in FIG. 7).

In some aspects, the techniques described herein relate to an apparatus, wherein overwriting the portion of the first data includes overwriting the first data using only those code words of the scrubbed data for which the corresponding updated latches indicate new data was not written during the write operation.

In some aspects, the techniques described herein relate to an apparatus including: a temporary storage location (e.g., 118); and at least one controller configured to: copy a page of stored data from a memory array to the temporary storage location for scrubbing to provide scrubbed data; write new data to the page in the memory array during the scrubbing; and update a portion of the page in the memory array using the scrubbed data.

In some aspects, the techniques described herein relate to an apparatus, wherein the updated portion of the page corresponds to code words of the page that are not changed by writing the new data.

In some aspects, the techniques described herein relate to an apparatus, wherein the page is a source page, and the scrubbed data is written from the temporary storage location to the source page in the memory array.

In some aspects, the techniques described herein relate to an apparatus, wherein the page is copied during a first scrubbing operation (e.g., first ECS operation), and the portion of the page is updated during a second scrubbing operation (e.g., second ECS operation).

In some aspects, the techniques described herein relate to an apparatus, wherein writing the new data occurs as part of a write operation performed in response to a write command from a host (e.g., host device 101), and the write operation is performed in parallel with the scrubbing of the copied page.

In some aspects, the techniques described herein relate to an apparatus, further including first error correction circuitry to correct errors in the new data, and second error correction circuitry to correct errors in the copied page.

In some aspects, the techniques described herein relate to an apparatus, wherein: the first error correction circuitry (e.g., 110) is coupled to a first bus (e.g., data path 804) for servicing read and write operations requested by a host device; the second error correction circuitry (e.g., 112) is coupled to a second bus (e.g., scrub loop 808) for scrubbing the copied page; and the second bus is separate from the first bus.

In one embodiment, a method of sharing an ECC engine across multiple pools is used for the purpose of facilitating ECC scrubs during ECS within a memory device.

In one example, memory device operation includes issuance of various commands. Non-limiting details regarding certain exemplary commands are provided below:
Memory device operation
   When activate to row address x is issued
      The row address x may be addressed by addressing bits on the activate command in the following manner
         Bank address (to specify which bank within the memory device).
         Row address (to specify which row within the specified bank).
      Word line associated with row address x brought high
      Sense page which causes data to reside in sense amp latches
   When a read command for column y of activated row address x is issued (read command must occur while a row is activated)
      Summary: read corrected data of the data that resides in the sense amplifier (SA) latches associated with column y.
      Note: read command contains the following addressing bits
         Bank address (to specify which bank within the memory device)
         Column address (to specify which column of the activated row within the specified bank)
      Full details:
         Note: Column y data is represented by the state of the SA latches associated with column y.
         Furthermore, column y is associated with a code word which consists of data bits and parity bits
         Data and parity from SA latches of the appropriate column fed through Code Word ECC Engine
         Error detection
         Syndrome generated based upon computed (parity calculated from data residing in “data” SA latches) and stored parity (parity stored directly in SA latches)
         Any correctable errors are corrected
         SA latch data remains unchanged
         Data output is corrected.
         Possibly corrected data sent out of memory device on DQs (IO pins) of memory device
   When a write command for column y of activated row address x is issued (write command must occur while a row is activated)
      Summary: alter SA latches associated with column y to contain new write data and associated parity.
      Note: write command contains the following addressing bits
         Bank address (to specify which bank within the memory device)
         Column address (to specify which column of the activated row within the specified bank)
      Full details
         Data input from DQs (IO pins) of memory device
         Data fed through Code Word ECC Engine
         Parity generated based upon input data
         Input data and generated parity (code word) written into the SA latches of the appropriate column
   When precharge command is issued
      Summary: A precharge command will result in an implicit write to the cells and then the word line is brought low
         The cells will now contain the data (all the data and all the parity of all the code words) residing with the SA latches.
      Note: precharge command contains the following addressing bits
         Bank address (whatever row is activated in the bank is precharged)
      Full details:
         Write page data into memory cells.
         Data residing within all SA latches written to memory cells
         Word line associated with row address x brought low after data is written into the memory cells

A non-limiting example of a memory device is now described.
Various details regarding use of a code word ECC engine are presented below:
   Various details are provided below as to the operation and behavior of the memory device:
      Memory array behavior
         On activate commands (ACTs): Sense page of memory array which causes data to reside in sense amplifier (or simply “sense amp”) latches
         On precharge commands (PREs): Write data in sense amp latches into page of memory array
      Code Word ECC Engine behavior
         On Writes
         Data input from DQs (IO pins) of memory device
         Data fed through Code Word ECC Engine
         Parity generated based upon input data
         Input data and generated parity (code word) written into the sense amplifier (SA) latches of the appropriate column
         On Reads
         Data from SA latches of the appropriate column fed through Code Word ECC Engine
         Syndrome generated based upon computed and stored parity (error detection)
         Any correctable errors are corrected
         SA latch data remains unchanged
         Data output is corrected
         Possibly corrected data sent out of memory device on DQs

The disclosure includes various devices which perform the methods and implement the systems described above, including data processing systems which perform these methods, and computer-readable media containing instructions which when executed on data processing systems cause the systems to perform these methods.

The description and drawings are illustrative and are not to be construed as limiting. Numerous specific details are described to provide a thorough understanding. However, in certain instances, well-known or conventional details are not described in order to avoid obscuring the description. References to one or an embodiment in the present disclosure are not necessarily references to the same embodiment; and, such references mean at least one.

As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

In this description, various functions and/or operations may be described as being performed by or caused by software code to simplify description. However, those skilled in the art will recognize what is meant by such expressions is that the functions and/or operations result from execution of the code by one or more processing devices, such as a microprocessor, Application-Specific Integrated Circuit (ASIC), graphics processor, and/or a Field-Programmable Gate Array (FPGA). Alternatively, or in combination, the functions and operations can be implemented using special purpose circuitry (e.g., logic circuitry), with or without software instructions. Embodiments can be implemented using hardwired circuitry without software instructions, or in combination with software instructions. Thus, the techniques are not limited to any specific combination of hardware circuitry and software, nor to any particular source for the instructions executed by a computing device.

While some embodiments can be implemented in fully functioning computers and computer systems, various embodiments are capable of being distributed as a computing product in a variety of forms and are capable of being applied regardless of the particular type of computer-readable medium used to actually effect the distribution.

At least some aspects disclosed can be embodied, at least in part, in software. That is, the techniques may be carried out in a computing device or other system in response to its processing device, such as a microprocessor, executing sequences of instructions contained in a memory, such as ROM, volatile RAM, non-volatile memory, cache or a remote storage device.

Routines executed to implement the embodiments may be implemented as part of an operating system, middleware, service delivery platform, SDK (Software Development Kit) component, web services, or other specific application, component, program, object, module or sequence of instructions (sometimes referred to as computer programs). Invocation interfaces to these routines can be exposed to a software development community as an API (Application Programming Interface). The computer programs typically comprise one or more instructions set at various times in various memory and storage devices in a computer, and that, when read and executed by one or more processors in a computer, cause the computer to perform operations necessary to execute elements involving the various aspects.

A computer-readable medium can be used to store software and data which when executed by a computing device causes the device to perform various methods. The executable software and data may be stored in various places including, for example, ROM, volatile RAM, non-volatile memory and/or cache. Portions of this software and/or data may be stored in any one of these storage devices. Further, the data and instructions can be obtained from centralized servers or peer to peer networks. Different portions of the data and instructions can be obtained from different centralized servers and/or peer to peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a computer-readable medium in entirety at a particular instance of time. Examples of computer-readable media include, but are not limited to, recordable and non-recordable type media such as volatile and non-volatile memory devices, read only memory (ROM), random access memory (RAM), flash memory devices, solid-state drive storage media, removable disks, magnetic disk storage media, optical storage media (e.g., Compact Disk Read-Only Memory (CD ROMs), Digital Versatile Disks (DVDs), etc.), among others. The computer-readable media may store the instructions. Other examples of computer-readable media include, but are not limited to, non-volatile embedded devices using NOR flash or NAND flash architectures. Media used in these architectures may include un-managed NAND devices and/or managed NAND devices, including, for example, eMMC, SD, CF, UFS, and SSD.

In general, a non-transitory computer-readable medium includes any mechanism that provides (e.g., stores) information in a form accessible by a computing device (e.g., a computer, mobile device, network device, personal digital assistant, manufacturing tool having a controller, any device with a set of one or more processors, etc.). A “computer-readable medium” as used herein may include a single medium or multiple media (e.g., that store one or more sets of instructions).

In various embodiments, hardwired circuitry may be used in combination with software and firmware instructions to implement the techniques. Thus, the techniques are neither limited to any specific combination of hardware circuitry and software nor to any particular source for the instructions executed by a computing device.

Various embodiments set forth herein can be implemented using a wide variety of different types of computing devices. As used herein, examples of a “computing device” include, but are not limited to, a server, a centralized computing platform, a system of multiple computing processors and/or components, a mobile device, a user terminal, a vehicle, a personal communications device, a wearable digital device, an electronic kiosk, a general purpose computer, an electronic document reader, a tablet, a laptop computer, a smartphone, a digital camera, a residential domestic appliance, a television, or a digital music player. Additional examples of computing devices include devices that are part of what is called “the internet of things” (IOT). Such “things” may have occasional interactions with their owners or administrators, who may monitor the things or modify settings on these things. In some cases, such owners or administrators play the role of users with respect to the “thing” devices. In some examples, the primary mobile device (e.g., an Apple iPhone) of a user may be an administrator server with respect to a paired “thing” device that is worn by the user (e.g., an Apple watch).

In some embodiments, the computing device can be a computer or host system, which is implemented, for example, as a desktop computer, laptop computer, network server, mobile device, or other computing device that includes a memory and a processing device. The host system can include or be coupled to a memory sub-system so that the host system can read data from or write data to the memory sub-system. The host system can be coupled to the memory sub-system via a physical host interface. In general, the host system can access multiple memory sub-systems via a same communication connection, multiple separate communication connections, and/or a combination of communication connections.

In some embodiments, the computing device is a system including one or more processing devices. Examples of the processing device can include a microcontroller, a central processing unit (CPU), special purpose logic circuitry (e.g., a field programmable gate array (FPGA), an application specific integrated circuit (ASIC), etc.), a system on a chip (SoC), or another suitable processor.

In one example, a computing device is a controller of a memory system. The controller includes a processing device and memory containing instructions executed by the processing device to control various operations of the memory system.

Although some of the drawings illustrate a number of operations in a particular order, operations which are not order dependent may be reordered and other operations may be combined or broken out. While some reordering or other groupings are specifically mentioned, others will be apparent to those of ordinary skill in the art and so do not present an exhaustive list of alternatives. Moreover, it should be recognized that the stages could be implemented in hardware, firmware, software or any combination thereof.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

1. An apparatus comprising:
a register; and
at least one controller configured to:
move data stored at an address in a memory array to the register;
scrub the data in the register to provide scrubbed data; and
write at least a portion of the scrubbed data to the address in the memory array.

2. The apparatus of claim 1, wherein an error check and scrub (ECS) counter points to the address in the memory array, and the controller is configured to increment the ECS counter after writing the portion of the scrubbed data to the address.

3. The apparatus of claim 1, wherein the data moved to the register is source data stored in the memory array, and writing the scrubbed data to the address comprises overwriting at least a portion of the source data in the memory array.

4. The apparatus of claim 1, wherein the controller is further configured to write new data to the address in the memory array while the data in the register is being scrubbed.

5. The apparatus of claim 4, wherein the data stored at the address is first data, and writing the scrubbed data to the address comprises overwriting only that portion of the first data not changed by writing the new data.

6. The apparatus of claim 1, wherein a first error check and scrub (ECS) operation is triggered by issuance of a first memory management command, and the data is moved during the first ECS operation.

7. The apparatus of claim 6, wherein a second ECS operation is triggered by issuance of a second memory management command, and the portion of the scrubbed data is written to the address during the second ECS operation.

8. An apparatus comprising:
a plurality of latches;
at least one memory array; and
at least one controller configured to:
scrub first data stored in the memory array to provide scrubbed data;
update the latches based on a write operation that occurs while scrubbing the first data; and
overwrite, using the scrubbed data and based on a state of the updated latches, at least a portion of the first data.

9. The apparatus of claim 8, wherein the memory array is configured in a volatile memory device, and the first data is scrubbed as part of an error check and scrub (ECS) operation.

10. The apparatus of claim 8, wherein the write operation causes a change to the first data in the memory array.

11. The apparatus of claim 8, wherein each of the latches corresponds to a code word.

12. The apparatus of claim 8, wherein each latch corresponds to a respective code word of the first data, and each latch is configured to indicate whether the respective code word has been written during the write operation.

13. The apparatus of claim 8, wherein overwriting the portion of the first data comprises overwriting the first data using only those code words of the scrubbed data for which the corresponding updated latches indicate new data was not written during the write operation.

14. An apparatus comprising:
a temporary storage location; and
at least one controller configured to:
copy a page of stored data from a memory array to the temporary storage location for scrubbing to provide scrubbed data;
write new data to the page in the memory array during the scrubbing; and
update a portion of the page in the memory array using the scrubbed data.

15. The apparatus of claim 14, wherein the updated portion of the page corresponds to code words of the page that are not changed by writing the new data.

16. The apparatus of claim 14, wherein the page is a source page, and the scrubbed data is written from the temporary storage location to the source page in the memory array.

17. The apparatus of claim 14, wherein the page is copied during a first scrubbing operation, and the portion of the page is updated during a second scrubbing operation.

18. The apparatus of claim 14, wherein writing the new data occurs as part of a write operation performed in response to a write command from a host, and the write operation is performed in parallel with the scrubbing of the copied page.

19. The apparatus of claim 14, further comprising first error correction circuitry to correct errors in the new data, and second error correction circuitry to correct errors in the copied page.

20. The apparatus of claim 19, wherein:
the first error correction circuitry is coupled to a first bus for servicing read and write operations requested by a host device;
the second error correction circuitry is coupled to a second bus for scrubbing the copied page; and
the second bus is separate from the first bus.
